(19) United States
(12) Patent Application Publication
(10) Pub. No.: US 2007/0291217 A1
(43) Pub. Date: Dec. 20, 2007

(54) DISPLAY SUBSTRATE, LIQUID CRYSTAL DISPLAY APPARATUS HAVING THE SAME AND METHOD FOR MANUFACTURING THE SAME

(76) Inventors: Min Kang, Seoul (KR); Byoung-Joo Kim, Gyeonggi-do (KR); Hwa-Yeul Oh, Gyeonggi-do (KR); Kyoung-Keun Son, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/744,624

(22) Filed: May 4, 2007

(30) Foreign Application Priority Data
Jun. 15, 2006 (KR) 2006-53700

(51) Int. Cl. G02F 1/1339

(52) U.S. Cl. 349/156

(57) ABSTRACT

A display substrate includes gate lines and source lines, a passivation layer, a light shielding layer, an overcoat layer, and a column spacer. The passivation layer includes a first hole, partially exposing the metal layer. The passivation layer is formed on the substrate having the metal layer formed thereon. The light shielding layer overlaps the metal pattern and includes a positive photosensitive material on the passivation layer. The light shielding layer includes a second hole corresponding to the first hole. The overcoat layer includes a positive photosensitive material on the substrate having the light shielding layer thereon. The overcoat layer includes a third hole corresponding to the second hole. The column spacer is protruded from the overcoat layer corresponding to a portion of the light shielding layer. Accordingly, the number of the exposing mask used for manufacturing the display substrate may be reduced.

### CROSS-REFERENCE TO RELATED APPLICATIONS

This application relies for priority upon Korean Patent Application No. 2006-53700, filed on Jun. 15, 2006, the contents of which are herein incorporated by reference in its entirety.

### BACKGROUND OF THE INVENTION

1. Field of the Invention

The present invention relates to a display substrate and, more particularly, to a liquid crystal display apparatus having the display substrate, and a method for manufacturing the display substrate, which are capable of decreasing manufacturing cost.

2. Description of the Related Art

Generally, a liquid crystal display panel includes a display substrate, an opposing substrate, and a liquid crystal layer disposed between the display substrate and the opposing substrate. The display substrate includes a plurality of pixel parts defined by a plurality of signal lines and a switching element formed in each pixel part. The opposing substrate is combined with the display substrate. The liquid crystal layer is disposed between the display substrate and the opposing substrate.

For example, the opposing substrate includes a color filter corresponding to each pixel part and a light shielding layer to prevent light leakage from the space between the pixel parts. The liquid crystal display panel further includes a supporting member disposed between the display substrate and the opposing substrate to support the cell gap for the liquid crystal layer.

Display quality of the liquid crystal display panel is severely influenced by how accurately each pixel part of the display substrate is combined with the color filter of the opposing substrate. When the display substrate and the opposing substrate are misaligned with each other, light generated by the light source may leak. Therefore, the color filter on array (COA) structure and the black matrix on array (BOA) structure have been developed to enhance the display quality. According to the color filter on array (COA) structure, the color filter is formed on the pixel part of the display substrate. According to the black matrix on array (BOA) structure, the light shielding layer is formed on the display substrate.

For example, a method for manufacturing a display substrate having the BOA structure includes forming a pixel layer having a gate line, a source line, and a switching element, forming a passivation layer, forming a light shielding layer, forming an overcoat layer, forming a pixel electrode, and forming a supporting member. Therefore, the conventional method employs four exposing masks after forming the pixel layer. Since the required exposing masks influence the manufacturing cost, in order to reduce the manufacturing cost, the number of patterning processes using the exposing mask must be reduced.

### BRIEF SUMMARY OF THE INVENTION

The present invention, according to one aspect thereof, provides a display substrate capable of decreasing the manufacturing cost of the liquid crystal display apparatus that includes a metal pattern, a passivation layer, a light shielding layer, an overcoat layer, and a column spacer. The metal pattern includes a plurality of gate and source lines substantially perpendicular to each other. The gate and source lines are insulated from each other and formed on a substrate. The passivation layer includes a first hole, which partially exposes the metal layer. The passivation layer is formed on the substrate having the metal layer formed thereon. The light shielding layer overlaps the metal pattern and includes a positive photosensitive material on the passivation layer. The light shielding layer includes a second hole corresponding to the first hole. The overcoat layer includes a positive photosensitive material. The overcoat layer is formed on the substrate having the light shielding layer formed thereon. The overcoat layer has a third hole corresponding to the second hole. The column spacer is protruded from the overcoat layer corresponding to a portion of the light shielding layer.

A display substrate according to another exemplary embodiment of the present invention includes a metal pattern, a light shielding layer, an overcoat layer, and a column spacer. The metal pattern includes a plurality of gate and source lines crossing each other. The gate and source lines are insulated from each other and formed on a substrate. The light shielding layer has a shape substantially the same as that of the metal pattern. The light shielding layer is formed on the substrate having the metal layer formed thereon. The overcoat layer is formed on the substrate having the light shielding layer thereon. The column spacer includes a material substantially the same as that of the overcoat layer.

A liquid crystal display apparatus according to an exemplary embodiment of the present invention includes a liquid crystal display panel and a backlight assembly providing the liquid crystal display panel with light. The liquid crystal display panel includes a first substrate, a second substrate opposite to the first substrate combined with the first substrate, and a liquid crystal layer disposed between the first and second substrates. The first substrate includes a pixel layer, a light shielding layer, an overcoat layer, a column spacer, and a pixel electrode. The pixel layer includes a plurality of pixel parts. The light shielding layer is formed on the pixel layer. The overcoat layer is formed on the light shielding layer. The column spacer is protruded from the overcoat layer. The pixel electrode corresponding to the pixel part is formed on the overcoat layer. The light shielding layer, the overcoat layer, and the column spacer includes a positive photosensitive material.

A method of manufacturing a display substrate according to an exemplary embodiment of the present invention includes spreading a first photosensitive material on a transparent substrate having a pixel layer, patterning the first photosensitive material by using light irradiated toward a rear surface of the transparent substrate to form a light shielding layer, spreading a second photosensitive material on the transparent substrate having the light shielding layer thereon, and patterning the second photosensitive material and the light shielding layer by using light irradiated toward a front surface of the transparent substrate to form an overcoat layer, a column spacer protruded from the overcoat layer, and a first hole penetrating the overcoat layer and the light shielding layer.

A method for manufacturing a display substrate according to another exemplary embodiment includes forming a first metal pattern including a gate line and a gate electrode of a switching element on a transparent substrate, forming a insulating layer on the first metal layer, spreading a source line metal for a source line and a light shielding material on the insulating layer, and patterning the source line metal and the light shielding material to form a second metal pattern including a source line crossing the gate line, a source electrode of the switching element, and a drain electrode of the switching element and a light shielding layer.

According to the display substrate, the liquid crystal display substrate having the display substrate, and the method of manufacturing a display substrate, the light shielding layer, the overcoat layer, the column spacer, and the contact hole may be formed by using a single mask. Therefore, manufacturing cost may be reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is a plane view illustrating a portion of a liquid crystal display panel according to an exemplary embodiment of the present invention;

FIG. 2 is a cross-sectional view taken along a line I-I′ in FIG. 1;

FIGS. 3A to 3H are cross-sectional views illustrating the processes for manufacturing the display substrate shown in FIG. 2;

FIG. 4 is a cross-sectional view illustrating a portion of a liquid crystal display panel according to another exemplary embodiment of the present invention; and

FIG. 5 is an exploded perspective view illustrating a liquid crystal display apparatus according to an exemplary embodiment of the present invention.

### DESCRIPTION OF THE EMBODIMENTS

The invention is described more fully hereinafter with reference to the accompanying drawings, in which embodiments of the invention are shown. In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

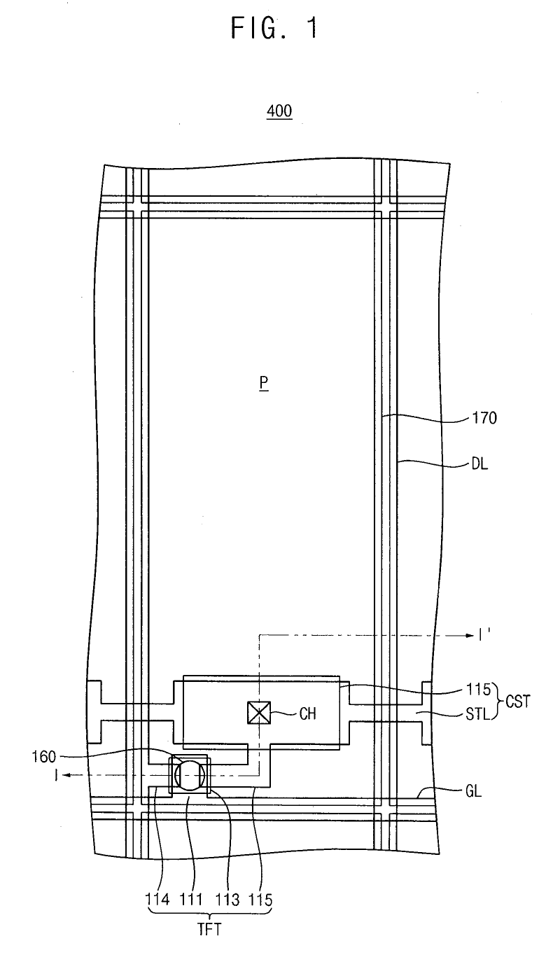

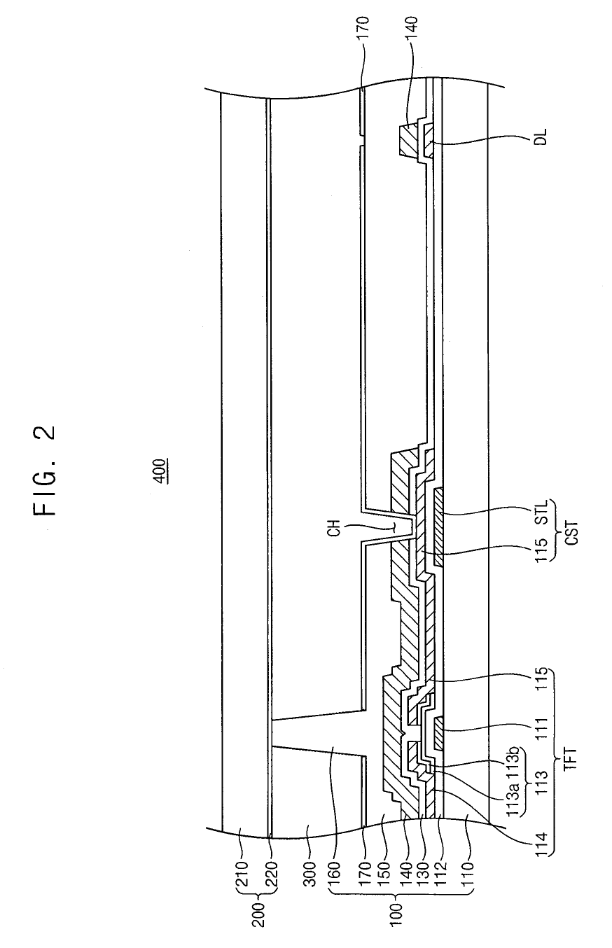

FIG. 1 is a plane view illustrating a portion of a liquid crystal display panel according to an exemplary embodiment of the present invention. FIG. 2 is a cross-sectional view taken along a line I-I′ in FIG. 1.

Referring to FIGS. 1 and 2, the liquid crystal display panel includes a display substrate 100, an opposite substrate 200, and a liquid crystal layer 300 disposed between the display substrate 100 and the opposite substrate 200.

The display substrate 100 includes a first transparent substrate 110, a gate line GL, a storage common line STL, a gate insulating layer 112, a source line DL, a switching element TFT, a passivation layer 130, a light shielding layer 140, an overcoat layer 150, a column spacer 160, and a pixel electrode 170.

The gate line GL is extended in a first direction on the first transparent substrate 110. The storage common line STL is disposed between the gate lines GL and extended in the first direction. The gate line GL and the storage common line STL may be formed from a same layer through the same manufacturing process. Namely, a first metal pattern includes the gate line GL and the storage common line STL.

The gate insulating layer 112 is formed on a front surface of the transparent substrate 110 having the gate line GL and the storage common line STL formed thereon. For example, the gate insulating layer 112 may include silicon nitride (SiNx) or silicon oxide (SiOx).

The source line DL is formed on the gate insulating layer 112 and extended in a second direction substantially perpendicular to the first direction. The gate and source lines substantially perpendicular to each other define a plurality of pixel parts P on the first transparent substrate 110.

The switching element TFT is formed on each of the pixel parts P. The switching element TFT includes a gate electrode 111, a channel layer 113, a source electrode 114, and a drain electrode 115.

The gate electrode 111 is connected to the gate line GL. The channel layer 113 overlaps the gate electrode 111 on the gate insulating layer 112. For example, the channel layer 113 has a structure that an active layer including amorphous silicon (a-Si:H) and an ohmic contact layer (n+a-Si) doped with a n+ ion at high concentration are sequentially stacked up.

The source electrode 114 is extended from the source line DL and partially overlaps the channel layer 113. The drain electrode 115 is spaced apart from the source electrode 114 by a predetermined distance and partially overlaps the channel layer 113. A second metal pattern includes the source line DL, the source electrode 114, and the drain electrode 115.

In the channel layer 113 corresponding to a space between the source electrode 114 and the drain electrode 115, the ohmic contact layer 113b is etched to expose the active layer 113a. The channel layer 113 becomes conductive when a voltage is applied to the gate electrode 111. However, the channel layer 113 is non-conductive when a voltage is not applied to the gate electrode 111. Namely, a pixel voltage provided by the source electrode DL is applied to the drain electrode 115 through the channel layer 113 when a timing signal is applied to the gate electrode 111. The drain electrode 115 is electrically connected to the pixel electrode 170 and operates as an output terminal applying the pixel voltage to the pixel electrode 170.

The drain electrode 115 partially overlaps the storage common line STL formed in each pixel part P and the gate insulating layer 112 is disposed between the drain electrode 115 and the storage common line STL overlapping each other. Therefore, the drain electrode 115, the storage electrode STL, and the gate insulating layer 112 form a storage capacitor Cst. The pixel voltage during a frame is charged on the storage capacitor Cst.

The passivation layer is formed on the first transparent substrate 110 having the switching element TFT thereon. For example, the passivation layer includes silicon nitride (SiNx) or silicon oxide (SiOx).

A light shielding layer 140 is formed on the passivation layer 130 and overlaps the first and second metal layers including the gate line GL and the source line DL. Namely, the light shielding layer 140 can have a shape substantially the same as that of the gate and source lines GL and DL. The light shielding layer 140 includes a photosensitive material and is patterned by using light radiated toward a rear surface of the first transparent substrate. The light shielding layer 140 shields light that may leak from an area between the pixel parts P that is not covered by the pixel electrode 170. The light shielding layer 140 also absorbs light entering upon a front surface to prevent light from being reflected by the lines of the metal patterns. The photosensitive material shielding light includes a positive photosensitive material, and a portion of the positive photosensitive material exposed to light is removed by a developing solution. For example, the light shielding layer 140 has a thickness of about 1 μm to 1.5 μm.

An overcoat layer 150 is formed on the passivation layer 130 having the light shielding layer 140 formed thereon. The overcoat layer includes a transparent positive photosensitive material. Also, the overcoat layer 150 may include a photosensitive organic material. The overcoat layer 150 smoothes the first transparent substrate 110 having the light shielding layer 140 formed thereon. For example, the overcoat layer 150 has a thickness of about 5 μm to 6 μm.

The passivation layer 130, the light shielding layer 140, and the overcoat layer 150 are sequentially stacked. A contact hole CH penetrating the passivation layer 130, the light shielding layer 140, and the overcoat layer 150 partially exposes the drain electrode 156.

The column spacer 160 protrudes from the overcoat layer 150. Therefore, the column spacer 160 includes a positive photosensitive material substantially the same as the overcoat layer 150. For example, the column spacer 160 and the overcoat layer 150 may include the same material.

The column spacer 160 corresponds to a portion of the light shielding layer 140. The column spacer 160 has a thickness substantially the same as that of the liquid crystal layer 300 to preserve the spacing distance between the display substrate 100 and the opposing substrate 200. For example, the column spacer 160 is formed on the light shielding layer 140 corresponding to the gate electrode 111.

The pixel electrode 170 corresponds to each pixel part P and is formed on the overcoat layer 150. The pixel electrode 170 contacts the drain electrode 115 through the contact hole CH. An opening pattern 181 corresponding to the column spacer 160 may be formed in the pixel electrode 170.

The pixel electrode 170 may include a transparent material, such as indium tin oxide (ITO), indium zinc oxide (IZO), and amorphous indium tin oxide (a-ITO), etc.

The overcoat layer 150, the light shielding layer 140, and the passivation layer 130 are formed under the pixel electrode 170 and electrically insulate the pixel electrode from the gate line GL and the source line DL. Therefore, the pixel electrode 170 is not electrically connected to the gate line GL and the source line DL even though the pixel electrode 170 overlaps the gate and source lines GL and DL on the overcoat layer 150. The pixel electrode 170 can be expanded to partially overlap the gate and source lines GL and DL defining each pixel part P.

Therefore, the area of the pixel electrode 170 increases, so that the opening ratio of the pixel part P is improved.

The opposing substrate 200 includes a second transparent substrate 210 and a common electrode 220.

The common electrode 220 includes a transparent conductive material on a front surface of the second transparent substrate 210. Since the light shielding layer 140 and the column spacer 160 are formed on the display substrate 100, processes of manufacturing the opposing substrate 200 are simplified.

The arrangement of liquid crystal molecules is changed by the electric field between the pixel electrode 170 and the common electrode 220 so that light can pass through the liquid crystal layer 300. Therefore, a display screen can display an image.

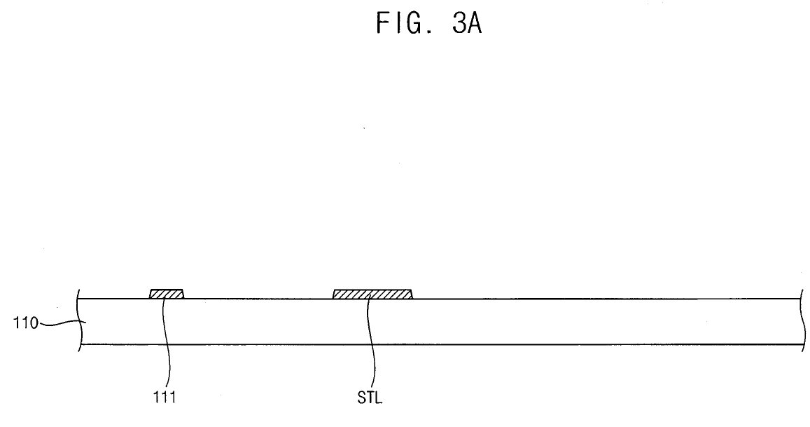

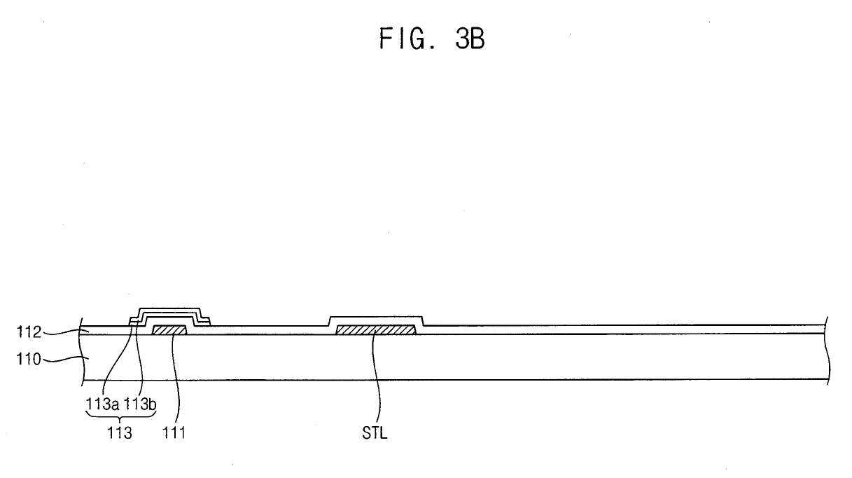

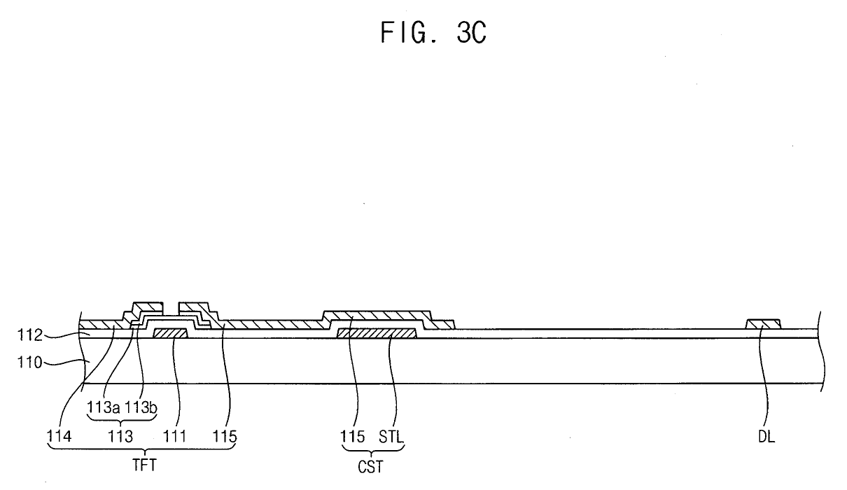

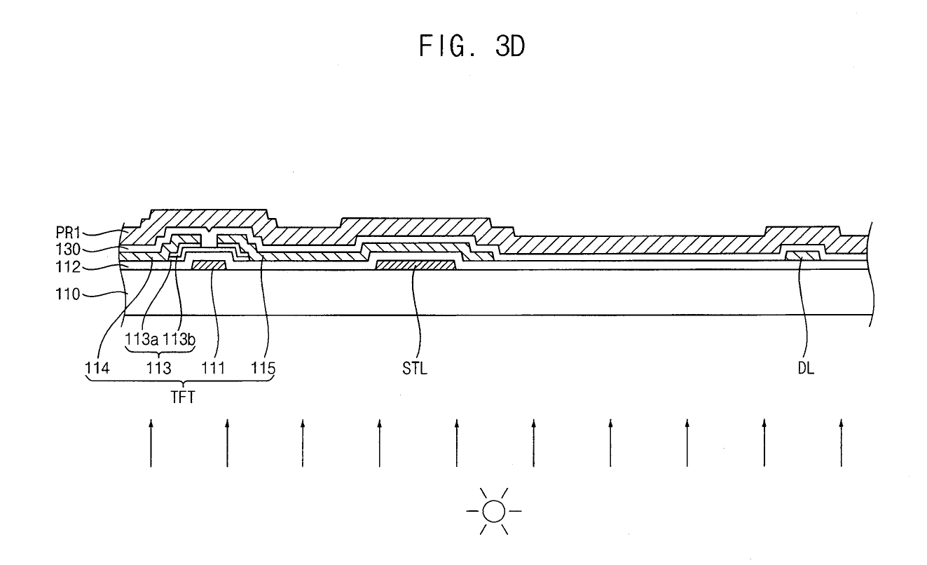

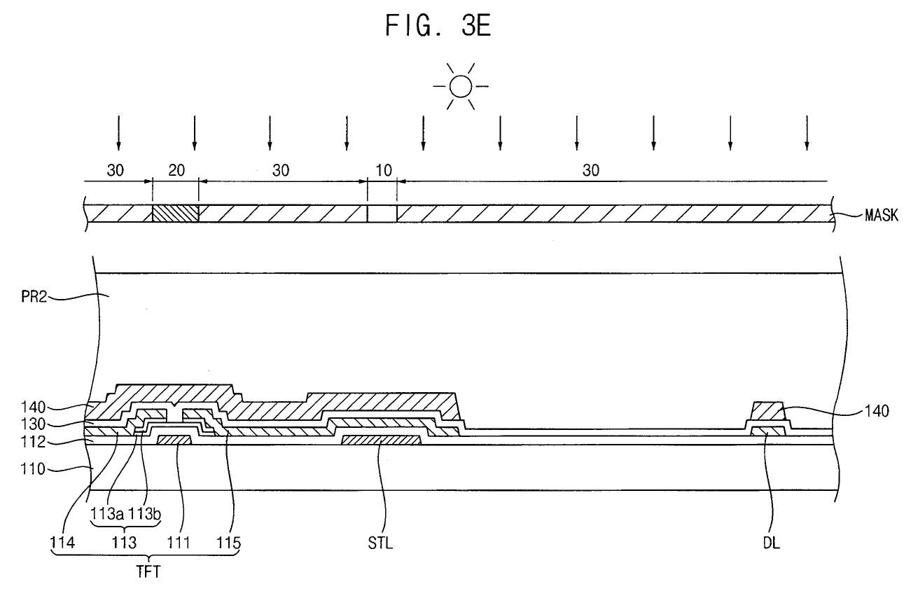

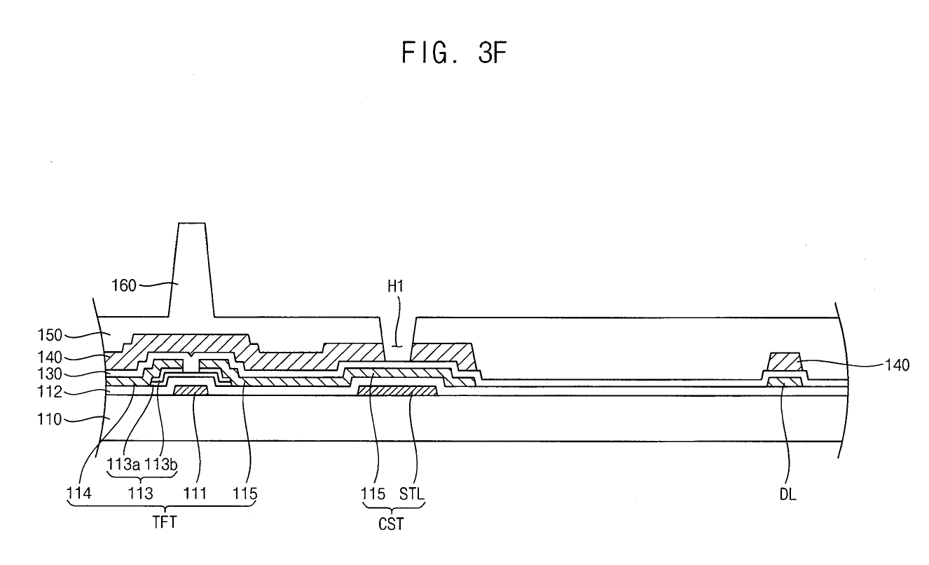

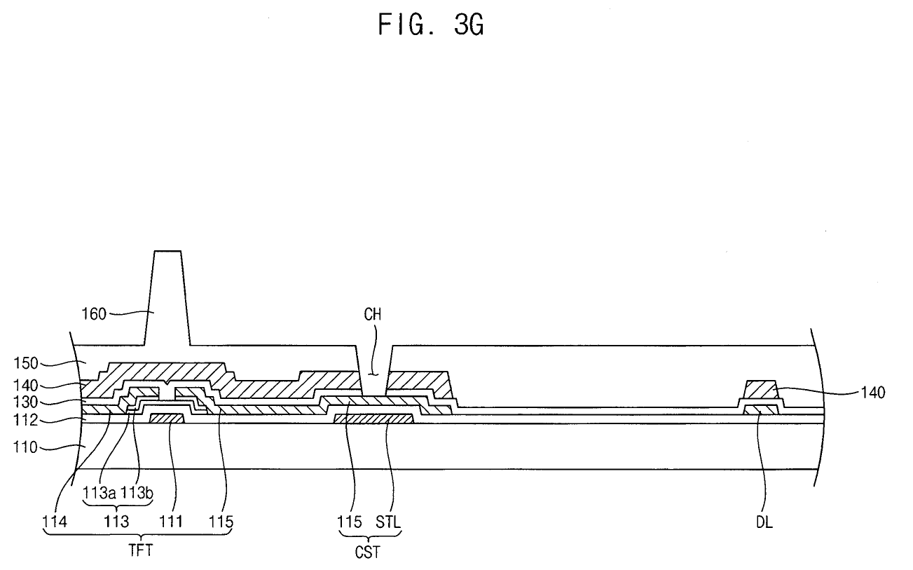

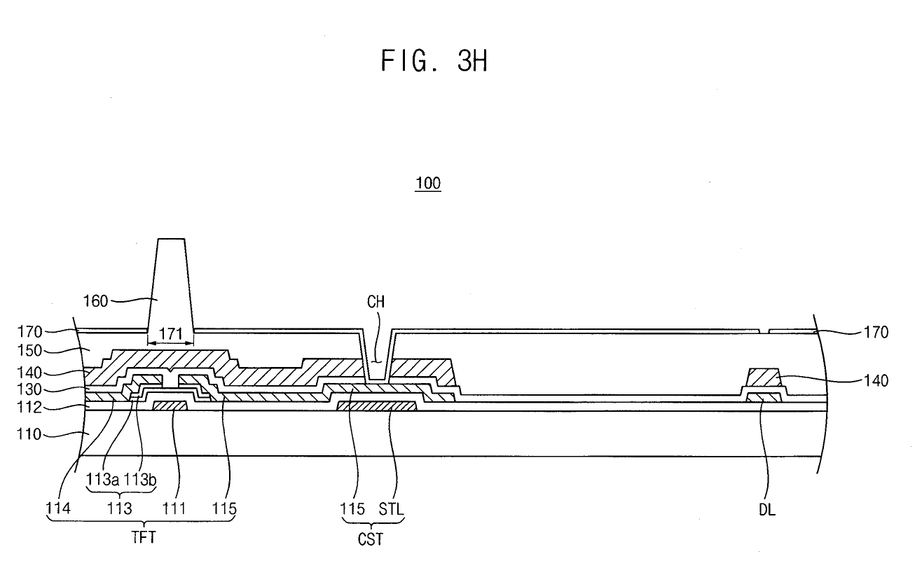

FIGS. 3A to 3H are cross-sectional views illustrating the processes for manufacturing the display substrate shown in FIG. 2. Hereinafter, a method for manufacturing a display substrate according to an exemplary embodiment of the present invention will be described with reference to FIGS. 3A to 3H.

Referring to FIGS. 1 and 3A, a first metal layer (not shown) is plated on the first transparent substrate 110. For example, the first metal layer includes a metal material or an alloy, such as chrome (Cr), aluminum (Al), tantalum (Ta), molybdenum (Mo), titanium (Ti), tungsten (W), copper (Cu), silver (Ag), etc. The first metal layer may be plated through a sputtering process. The first metal layer may include two layers mechanically different from each other.

Then, the first metal layer is patterned through a photo-etching process to form a first metal pattern including a gate line GL, a gate electrode 111 connected to the gate line GL, and a storage line STL.

Referring to FIGS. 1 and 3B, a gate insulating film 112 including silicon nitride (SiNx) or silicon oxide (SiOx) is formed on a first transparent substrate 110 having the first metal pattern formed thereon through a plasma enhance chemical vapor deposition method (PECVD).

Then, an active layer 113A and an ohmic contact layer 113B are sequentially stacked on the gate insulating layer 112 through the plasma enhance chemical vapor deposition method (PECVD). The gate insulating layer 112 having the active layer 113A and the ohmic contact layer 113B thereon is patterned through the photo-etching method to form a channel layer 113 overlapping the gate electrode 111. For example, the channel layer 113 is etched through a dry etching method.

Referring to FIGS. 1 and 3C, a second metal layer is plated on the gate insulating layer 112 having the channel layer 113 formed thereon. The second metal layer includes a metal or an alloy, such as chrome (Cr), aluminum (Al), tantalum (Ta), molybdenum (Mo), titanium (Ti), tungsten (W), copper (Cu), silver (Ag), etc. The second metal layer may be plated through a sputtering process. The second metal layer may include two layers mechanically different from each other.

The second metal layer is patterned through the photo-etching method to form a second metal pattern including a source line DL, a source electrode 114, and a drain electrode 115.

The source electrode 114 is connected to the source line DL and partially overlaps the channel layer 113. The drain electrode 115 is spaced apart from the source electrode 114 by a predetermined distance. One terminal of the drain electrode 115 overlaps the channel layer 113 and the other terminal of the drain electrode 115 overlaps the storage common electrode STL.

Then, the ohmic contact layer 113A corresponding to the space between the source and drain electrodes 114 and 115 is etched. For the etching process of the ohmic contact layer 113A, the source and drain electrode 114 and 115 are used as an etching mask. Therefore, a switching element TFT including the gate electrode 111, the channel layer 113, the source electrode 114, and the drain electrode 115 is formed on the first transparent substrate 110.

Referring to FIGS. 1 and 3D, a passivation layer 130 is formed on the first transparent substrate 110 having the switching element TFT formed thereon. For example, the passivation layer 130 includes silicon nitride (SiNx) or silicon oxide (SiOx) and is formed through the plasma enhance chemical vapor deposition method (PECVD). Then, a first photosensitive material PR1 shielding light is spread on the passivation layer 130. The first photosensitive material PR1 includes a positive photosensitive material that a portion of the positive photosensitive material exposed to light is removed by a developing solution.

Then, the first photosensitive material PR1 is exposed to light radiated toward a rear surface of the first transparent substrate 110. Since the first and second metal patterns include metal shield light, a portion of the first photosensitive material formed on the first and second metal patterns is not exposed to light. Then, the first photosensitive material PR1 is developed by a developing solution. The portion of the first photosensitive material exposed to light is removed, and the portion of the first photosensitive material PR1 formed on the first and second metal patterns remains.

Referring to FIG. 3E, a light shielding layer 140 is formed on the passivation layer 130. The light shielding layer 140 overlaps the first and second metal patterns. The light shielding layer 140 shields light radiated toward the rear and front surface of the first transparent substrate 110 and absorbs the light. Then, a second photosensitive material PR2 is spread on the first transparent substrate 110 having the light shielding layer 140 formed thereon. The second photosensitive material PR2 includes the positive photosensitive material. The second photosensitive material PR2 may include an organic insulating material having a low dielectric constant. For example, the dielectric constant value is about 4 or less. Then, an exposing mask including a transmitting part 10, a shielding part 20, and a diffracting part 30 is arranged on the first transparent substrate 110. The exposing mask includes a half-tone mask having a half-tone layer formed on an area corresponding to the diffracting part 30. The exposing mask may include a slit mask including a metal layer having a minute pattern formed on an area corresponding to the diffracting part 30.

For example, the transmitting part 10 is disposed in an area corresponding to a portion of the light shielding layer 140. For example, the transmitting part 10 is disposed in an area corresponding to a portion of the drain electrode 115. The light shielding part 20 is disposed in an area corresponding to a portion of the light shielding layer 140 not to overlap the transmitting part 10. For example, the light shielding part 20 is disposed in an area corresponding to the gate electrode 111. The diffracting part 30 is disposed in the remaining area except for the transmitting part 10 and the shielding part 20.

When light is radiated onto the exposing mask, the transmitting part 10 transmits the light and the shielding part 20 shields the light. The diffracting part 30 diffracts the light so that some of the light is transmitted through the exposing mask.

When the second photosensitive material PR2 exposed to the light through the exposing mask is developed, a portion of the second photosensitive material PR2 corresponding to the transmitting part 10 is dissolved to be removed. A portion of the second photosensitive material PR2, corresponding to the shielding part 20, remains with a thickness substantially the same as that of the second photosensitive material PR2 before the second photosensitive material PR2 is developed. A portion of the second photosensitive material PR2 remains having a thickness that is thinner than that of the second photosensitive material PR2 before the second photosensitive material PR2 is developed.

Referring to FIG. 3F, an overcoat layer 150 and a column spacer 160 protruding from the overcoat layer 150 are simultaneously formed on the first transparent substrate 110. Also, referring to FIGS. 3E and 3F, a first hole H1 is formed in a portion of the overcoat layer 150 corresponding to the transmitting part 10.

In an exposing process shown in FIG. 3E, a portion of the light shielding layer 140 corresponding to the transmitting part 10 is also removed since the light shielding layer 140 includes a positive photosensitive material substantially the same as the second photosensitive material PR2. Therefore, the first hole H1 formed in an area corresponding to the transmitting part 10 passes through the overcoat layer 150 and the light shielding layer 140 and partially exposes the passivation layer 130 formed on the drain electrode 115.

Referring to FIG. 3G, a hardening process is performed on the overcoat layer 150, the column spacer 160, and the light shielding layer 140. Then the exposed portion of the passivation layer 130 is etched. In the etching of the passivation layer 130, the overcoat layer 150 and the light shielding layer 140 are used as an etching mask. The passivation layer 130 may be etched through the dry etching method. As a result, a contact hole CH partially exposing the drain electrode is formed.

As mentioned above, the exemplary embodiment of the present invention employs only one exposing mask to form the light shielding layer 140, the overcoat layer 150, the column spacer 160, and the contact hole CH. Therefore, the manufacturing cost of the display substrate can be reduced.

Referring to FIGS. 1 and 3H, a transparent conductive material (not shown) is formed on the first transparent substrate 110 having the drain electrode 115 exposed by the first hole H1. For example, the transparent conductive material includes indium tin oxide, indium zinc oxide, and amorphous indium tin oxide, etc. and is plated through a sputtering method. Then, the transparent conductive material is patterned through a photo-etching method to form a pixel electrode 170 corresponding to each pixel part P. The pixel electrode 170 contacts with the drain electrode 115 through the contact hole CH and receives a pixel voltage from the drain electrode 115.

The overcoat layer 150, the light shielding layer 140, and the passivation layer 130 are formed under the pixel electrode 170 and electrically insulate the pixel electrode from the gate line GL and the source line DL. Therefore, the pixel electrode 170 is not electrically connected to the gate line GL and the source line DL though the pixel electrode 170 overlaps the gate and source lines GL and DL on the overcoat layer 150. The pixel electrode 170 can be expanded to partially overlap the gate and source lines GL and DL defining each pixel part P. Therefore, the area of the pixel electrode 170 increases so that the opening ratio of the pixel part P is improved.

When the column spacer 160 is disposed in an area of the pixel electrode 170, an opening pattern 171 corresponding to the column spacer 160 can be formed in the pixel electrode to prevent an electric short circuit between the pixel electrode 170 and the common electrode formed on the opposing substrate.

According to an exemplary embodiment of the present invention, the gate and source lines GL and DL are formed, and then a material having a low reflectivity is plated on the gate and source lines GL and DL. Then, the material and gate and source lines GL and DL are simultaneously patterned to form the light shielding layer. Also, the light shielding layer can be formed on the gate line GL and the source line DL respectively. The material having a low reflectivity includes chrome oxide (CrOx).

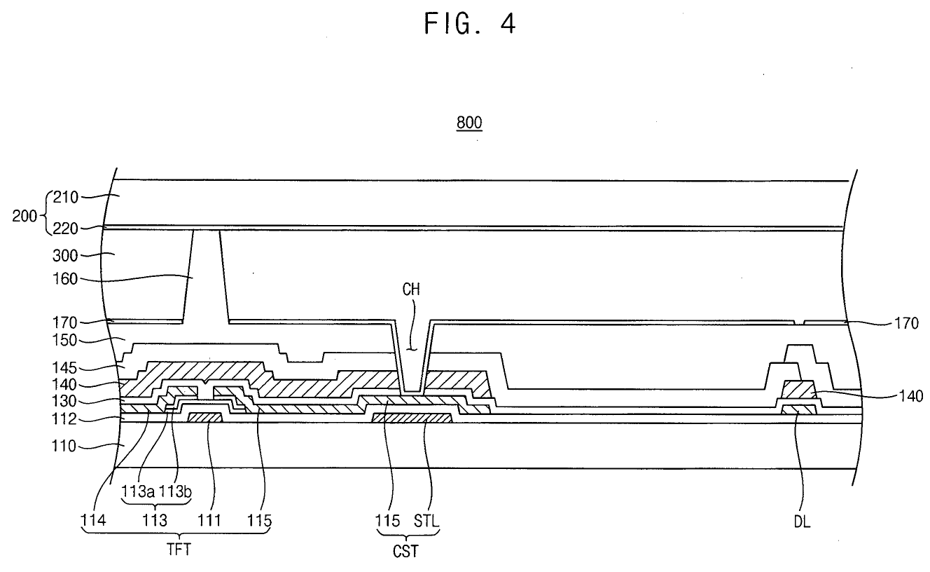

FIG. 4 is a cross-sectional view illustrating a portion of a liquid crystal display panel 800 according to another exemplary embodiment of the present invention.

The liquid crystal display panel 800 shown in FIG. 4 is similar to that 400 shown in FIG. 2. Thus, and the same reference numerals will be used to refer to the same or like parts as those described in the liquid crystal display panel 400 shown in FIG. 2 and any further repetitive explanation concerning the above elements will be omitted.

Referring to FIG. 4, the liquid crystal display panel 800 according to an exemplary embodiment of the present invention further includes a color filter 145 formed between the light shielding layer 140 and the overcoat layer 150.

The color filter 145 is formed in an area corresponding to each pixel part P. A contact hole CH passes through the passivation layer 130, the light shielding layer 140, and the overcoat layer 150. The color filter 145 can include a positive photosensitive material having red, green, and blue colors. Also, the color filter 145 may include a negative photosensitive material having red, green, and blue colors. When the color filter 145 includes the positive photosensitive material, the contact hole CH can simultaneously pass through the light shield layer 140, the color filter 145, and the overcoat layer 150 while the overcoat layer 150 and the column spacer 160 are formed.

When the color filter 145 includes the negative photosensitive material, a hole corresponding to the contact hole CH is formed beforehand while a patterning process for forming the color filter 145. Then, a process for forming the overcoat layer 150 and the column spacer 160 substantially the same as that of the first exemplary embodiment is performed to form the overcoat layer 150 and the column spacer 160.

Though not shown, the color filter 145 may be formed between the overcoat layer 150 and the pixel electrode 170. Also, a positive photosensitive material is spread on the light shielding layer 140, and then the photosensitive material may be patterned through a method substantially the same as that of the first exemplary embodiment so that the color filter, and the column spacer and the contact hole connected to the color filter are simultaneously formed.

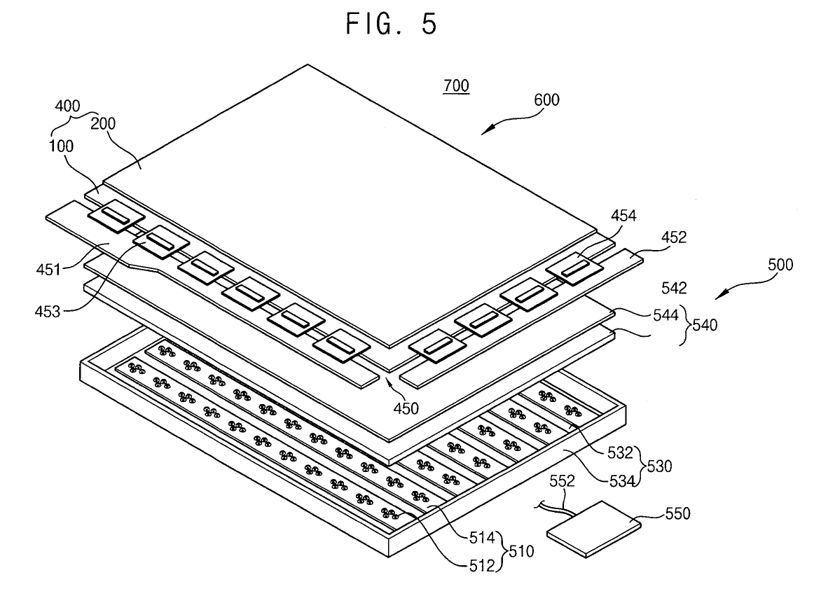

FIG. 5 is an exploded perspective view illustrating a liquid crystal display apparatus 700 according to an exemplary embodiment of the present invention.

Referring to FIG. 5, the liquid crystal display apparatus 700 includes a backlight assembly 500 and a display unit 600.

The backlight assembly 500 includes a plurality of light source units 510, a receiving container 530, and an optical member 540.

Each of the light source units 510 includes a plurality of light sources 512 and a circuit board 514. The light sources 512 respectively emit lights having a wavelength different from each other. The light sources 512 are mounted on the circuit board 514.

For example, the circuit board 514 includes a printed circuit board and a metal coating board that a conductive metal is coated on a printed circuit board. The circuit board 514 includes a power supply line (not shown) for applying power provided from exterior of the light sources.

The light sources 512 include red, green, and blue light sources. For example, one light source group is defined by one red light source, two green light sources, and one blue light source. A plurality of the light source groups is spaced apart from each other on the circuit board 514. However, respective numbers of the red, green, and blue light sources defining one light source group is not limited to the exemplary embodiment mentioned above.

For example, the red light source includes a red light emitting diode emitting a red-colored light, the green light sources include green light emitting diodes emitting a green-colored light, and the blue light source includes a blue light emitting diode emitting a blue-colored light.

The receiving container 530 includes a bottom plate 532 and a lateral part 534 extended from the bottom plate 532 to form a receiving space. The receiving container 530 sequentially receives the light source units 510 and the optical member 540. For example, the receiving container 530 includes metal having a high intensity and a low strain rate.

The optical member 540 is disposed on the light source units 520. The optical member 540 includes a diffusion plate 542 diffusing light generated by the light source units 520. The optical member 540 may further include an optical sheet 544 enhancing properties of the light diffused by the diffusion plate 542. For example, the optical sheet 544 includes a diffusion sheet diffusing the light diffused by the diffusion plate 542 again and/or a light concentrating sheet concentrating the light diffused by the diffusion plate and sheet to enhance a property of a front brightness.

The backlight assembly 500 may further include a power supply device 550 providing the light source units 520 with a driving voltage to drive the light source units 520. The driving voltage generated by the power supply device is applied to the light source units 520 through a power line 552.

The display unit 600 includes a liquid crystal display panel 400 to display an image by using the light provided by the backlight assembly 500 and a driving circuit part 450 for driving the liquid crystal display panel 400.

The liquid crystal display panel 400 is substantially the same as that shown in FIGS. 1 and 2. Thus, the same reference numerals will be used to refer to the same or like parts as those described in the liquid crystal display panel 400 shown in FIGS. 1 and 2 and any further repetitive explanation concerning the above elements will be omitted. The liquid crystal display panel 400 includes a first substrate 100, a second substrate 200 opposing to the first substrate 100, and a liquid crystal layer (not shown) disposed between the first and second substrates 100 and 200.

The liquid crystal display apparatus 700 employs a backlight assembly having a color driving method according to which red, green, and blue colored lights are sequentially emitted during a predetermined time to embody a wanted color. Thus, the liquid crystal display panel 400 does not include a color filter.

The driving circuit 450 includes a data printed circuit board 451, a gate printed circuit board 452, a data driving circuit film 453, and a gate driving circuit film 454. The data printed circuit board 451 provides the liquid crystal display panel 400 with a data driving signal. The gate printed circuit board 452 provides the liquid crystal display panel 400 with a gate driving signal. The data driving circuit film 453 connects the data printed circuit board 451 with the liquid crystal display panel 400. The gate driving circuit board 454 connects the gate printed circuit board 452 with the liquid crystal display panel 400.

According to the present invention, a positive type first photosensitive material is patterned by using light radiated toward the rear surface of the display substrate to form the light shielding layer. Then, a positive type second photosensitive material is formed on the light shielding layer, and the first and second photosensitive materials are patterned by light radiated toward the front surface of the display substrate to form the light shielding layer, the overcoat layer, the column spacer, and the contact hole. Namely, the light shielding layer, the overcoat layer, the column spacer, and the contact hole are formed by using only one exposing mask. Therefore, the number of the exposing masks employed for manufacturing the display substrate is reduced and manufacturing cost is also reduced.

Having described the exemplary embodiments of the present invention and its advantage, it is noted that various changes, substitutions and alterations can be made herein without departing from the spirit and scope of the invention as defined by appended claims.

What is claimed is:

1. A display substrate comprising:
a metal pattern formed on a substrate, the metal pattern including a plurality of gate and source lines substantially perpendicular to each other, the gate and source lines being insulated from each other;
a passivation layer formed on the substrate having the metal pattern formed thereon, the passivation layer having a first hole, which partially exposes the metal layer;
a light shielding layer overlapping the metal layer on the passivation layer, the light shielding layer including a positive photosensitive material, and having a second hole corresponding to the first hole;
an overcoat layer formed on the substrate having the light shielding layer formed thereon, the overcoat layer including a positive photosensitive material and having a third hole corresponding to the second hole; and
a column spacer protruded from the overcoat layer corresponding to a portion of the light shielding layer.

2. The display substrate of claim 1, wherein the overcoat layer and the column spacer include a same material.

3. The display substrate of claim 1, wherein a shape of the light shielding layer is substantially the same as that of the metal layer.

4. The display apparatus of claim 1, further comprising a pixel electrode formed on the overcoat layer, the pixel electrode corresponding to a pixel part defined by gate and source lines crossing each other and being insulated from each other.

5. The display substrate of claim 4, wherein the pixel electrode partially overlaps the gate and source lines defining the pixel part.

6. The display substrate of claim 5, wherein an opening is formed at a portion of the pixel electrode, which corresponds to the column spacer.

7. The display substrate of claim 1, further comprising a color filter having a fourth hole corresponding to the first hole, the fourth hole being formed between the light shielding layer and the overcoat layer.

8. A display substrate comprising:
a metal pattern formed on a substrate, the metal pattern including gate and source lines crossing each other, the gate and source lines being insulated from each other;
a light shielding layer formed on the substrate having the metal pattern formed thereon, the light shielding layer having a shape substantially the same as that of the metal pattern;
an overcoat layer formed on the substrate having the light shielding layer formed thereon; and
a column spacer including a material substantially the same as that of the overcoat layer.

9. The display substrate of claim 8, further comprising a pixel electrode formed on the overcoat layer, the pixel electrode partially overlapping the gate and source lines.

10. The display substrate of claim 9, wherein an opening is formed at a portion of the pixel electrode corresponding to the column spacer.

11. A liquid crystal display apparatus comprising:
a liquid crystal display panel including:
a first substrate including:
a pixel layer including a plurality of pixel parts;
a light shielding layer formed on the pixel layer, the light shielding layer including a positive photosensitive material; an overcoat layer formed on the light shielding layer, the overcoat layer including the positive photosensitive material;
a column spacer protruded from the overcoat layer, the column spacer including the positive photosensitive material; and
a pixel electrode formed on the overcoat layer, the pixel electrode corresponding to the pixel parts;
a second substrate facing the first substrate;
a liquid crystal layer disposed between the first and second substrates; and
a backlight assembly providing the liquid crystal display panel with light.

12. The liquid crystal display apparatus of claim 11, wherein the backlight assembly sequentially emits red light, green light, and blue light for a predetermined time to embody a wanted color.

13. The liquid crystal display apparatus of claim 11, further comprising a passivation layer disposed between the pixel layer and the light shielding layer.

14. The liquid crystal display apparatus of claim 11, wherein the pixel layer comprises a plurality of gate and source lines crossing each other and defining a plurality of pixel parts, and a switching element formed in each of the pixel part, the switching element being connected to the gate and source lines.

15. The liquid crystal display apparatus of claim 14, wherein the pixel electrode partially overlaps the gate and source lines defining the pixel parts.

16. The liquid crystal display apparatus of claim 14, wherein the shape of the light shielding layer is substantially the same as that of a metal pattern including the gate and source lines, and the switching element.

17. The liquid crystal display apparatus of claim 14, further comprising a contact hole that is formed through the passivation layer, the light shielding layer, and the overcoat layer and exposes an output terminal of the switching element.

18. The liquid crystal display apparatus of claim 11, further comprising a color filter corresponding to the pixel part, the color filter being disposed between the light shielding layer and the overcoat layer.

19. A method for manufacturing a display substrate, comprising:
spreading a first photosensitive material on a transparent substrate having a pixel layer formed thereon;
patterning the first photosensitive material by using a light irradiated toward a rear surface of the transparent substrate to form a light shielding layer;
spreading a second photosensitive material on the transparent substrate having the light shielding layer formed thereon; and
patterning the light shielding layer and the second photosensitive material by using light irradiated toward a front surface of the transparent substrate to form an overcoat layer, a column spacer protruded from the overcoat layer, and a first hole penetrating the overcoat layer and the light shielding layer.

20. The method of claim 19, wherein the overcoat layer and the light shielding layer are simultaneously penetrated during patterning the light shielding layer and the second photosensitive material by using light irradiated toward a front surface of the transparent substrate to form the overcoat layer, the column spacer protruded from the overcoat layer, and the first hole penetrating the overcoat layer and the light shielding layer.

21. The method of claim 19, wherein each of the first and second photosensitive materials is a positive photosensitive material, and a portion of the positive photosensitive material exposed by light is removed by a developing solution.

22. The method of claim 19, wherein the pixel layer comprises:
a first metal pattern including a gate line and a gate electrode of a switching element;
an insulating layer formed on the first metal pattern; and
a second metal pattern including a source line formed on the insulating layer, crossing the gate line, a source electrode of the switching element, and a drain electrode of the switching element.

23. The method of claim 22, wherein the light shielding layer has the same shape as the shape of the first metal pattern and the second metal pattern.

24. The method of claim 22, further comprising forming a pixel electrode on the overcoat layer, the pixel electrode being electrically connected to the drain electrode through the first hole.

25. The method of claim 22, further comprising:
forming a passivation layer disposed between the pixel layer and the light shielding layer; and
etching the passivation layer exposed through the first hole to partially expose the drain electrode.

26. The method of claim 19, wherein patterning the light shielding layer and the second photosensitive material comprises:
arranging a mask over the transparent substrate having the second photosensitive material formed thereon, the mask including a transmitting part corresponding to the first hole, a shielding part corresponding to the column spacer, and a diffracting part, which is a remaining portion of the mask except for the transmitting part and the shielding part;
radiating light onto the transparent substrate having the second photosensitive material over the mask; and
developing the second photosensitive material exposed by the light.

27. The method of claim 19, further comprising forming a color filter having a second hole disposed between the light shielding layer and the overcoat layer, the second hole corresponding to the first hole.

28. A method for manufacturing a display substrate, comprising:
forming a first metal pattern including a gate line and a gate electrode of a switching element on a transparent substrate;
forming an insulating layer on the first metal pattern;
spreading a source line metal for a source line and a light shielding material on the insulating layer; and
patterning the source line metal and the light shielding material to form a second metal pattern including the source line crossing the gate line, a source electrode of the switching element, and a drain electrode of the switching element and a light shielding layer.

29. The method of claim 28, further comprising:
spreading a photosensitive resin on the transparent substrate having the light shielding layer formed thereon; and
patterning the photosensitive resin by using light irradiated toward a front surface of the transparent substrate to form an overcoat layer, a column spacer protruding from the overcoat layer, and a first hole penetrating the light shielding layer and the overcoat layer.
